(19) United States
(12) Patent Application Publication
(10) Pub. No.: US 2020/0233907 A1
(43) Pub. Date: Jul. 23, 2020

(54) LOCATION-BASED FILE RECOMMENDATIONS FOR MANAGED DEVICES

(71) Applicant: VMWARE, INC., Palo Alto, CA (US)

(72) Inventors: Shajil John, Bangalore (IN); Gnana Guru, Bangalore (IN); Jubin Benny, Bangalore (IN)

(21) Appl. No.: 16/367,287

(22) Filed: Mar. 28, 2019

(30) Foreign Application Priority Data
Jan. 18, 2019 (IN) 201941002297

(51) Int. Cl. G06F 16/907; G06F 16/901; H04L 29/06; H04L 29/08

(52) U.S. Cl. CPC G06F 16/907; H04L 67/06; H04L 67/42; G06F 16/901

(57) ABSTRACT

Disclosed are various examples for recommending files available to access for managed devices in an enterprise setting. When a user requests access to a file using a file management application on a managed device, a file request can be transmitted to a management service. The management service can associate the file to a device location and organization group identifier included in the file request. When another user in the same organization group accesses the file management application at the same location, the management service can recommend files that have been previously linked to the device location and organization group identifier. The file management application can present the recommended files to the user.

### RELATED APPLICATIONS

Benefit is claimed under 35 U.S.C. 119(a)-(d) to Foreign Application Serial No. 201941002297 filed in India entitled “LOCATION-BASED FILE RECOMMENDATIONS FOR MANAGED DEVICES”, on Jan. 18, 2019, by VMWARE, Inc., which is herein incorporated in its entirety by reference for all purposes.

### BACKGROUND

With the emergence of bring-your-own-device (BYOD) technology in the workplace, enterprises permit employees or other personnel to use their own devices for business purposes. This can include accessing enterprise data, such as email and corporate documents. However, prior to an employee using his or her own device in the workplace, a company can require the employee to enroll with a management service capable of protecting enterprise data from theft, loss, and unauthorized access. Administrators can utilize the management service to oversee operation of the devices enrolled with or otherwise managed by the service.

Typically, devices such as laptops, tablets, and mobile phones are required to abide by the enterprise policies. Managed devices can also include one or more programs that can access, manage, edit, or perform functions with respect to enterprise data. In some situations, access to one or more of the files can be restricted. A user can be presented a file directory that includes available files that can be available to the user.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example of a networked environment, including a management system and a client device.

FIG. 2 is an example of a diagram illustrating functionality implemented by components of the networked environment.

FIGS. 3 and 4 are example flowcharts illustrating functionality implemented by components of the networked environment.

### DETAILED DESCRIPTION

The present disclosure relates to providing file recommendations to users in an enterprise according to device location and organization group. User devices in the enterprise can be managed by a management service capable of protecting enterprise data from theft, loss, and unauthorized access. The user devices can include a file management application that allows users to access, manage, edit, or perform other functions with respect to published files of the enterprise. As users request access to files through the file management application, the management service can use machine learning to identify relevant files to recommend to users according to a location of the user when requesting the file as well as an organization group of the user. According to various implementations, a recommended list of files can be presented to a user upon authentication of the user. The recommended list of files is selected based on the client location and organization group identifier, thereby allowing the user to bypass the traditional process of navigating through a file directory to locate the desired file.

In an enterprise setting, different employees access different files based on the organization group to which the employee belongs within the enterprise as well as the location of the user when accessing the document. A typical organization houses thousands of files that can be accessed by its employees for specific organizational tasks. For example, a delivery person of an organization will have to visit numerous client locations and each client location will have delivery and sales documents that have to be updated when a delivery occurs. A relationship manager of the organization can also visit the same locations as the delivery person, but visits the location to collect client feedback instead of delivery items. As such, the relationship manager and delivery person would be in different organization groups and would need to access different files to complete tasks associated with his or her position in the organization.

Typically, when a user arrives at a particular location, the user must navigate through a file directory containing a large quantity of published files to access the particular file required for a particular task. This process can be time consuming as the user navigates through the various published files to accesses the required file. In addition, this process can be erroneous as the user can access and modify the wrong file for the particular location. Further, in situations where a document is suggested to a user solely based on a location of the requesting device, the document may not be relevant to the particular user. For example, the suggested document may not be a document used by the user with respect to tasks associated with the user or the organization group of the user. Accordingly, it can be beneficial to simplify file access to end users by providing the user with file recommendations based on the organization group of the user and the current location of the user accessing the documents.

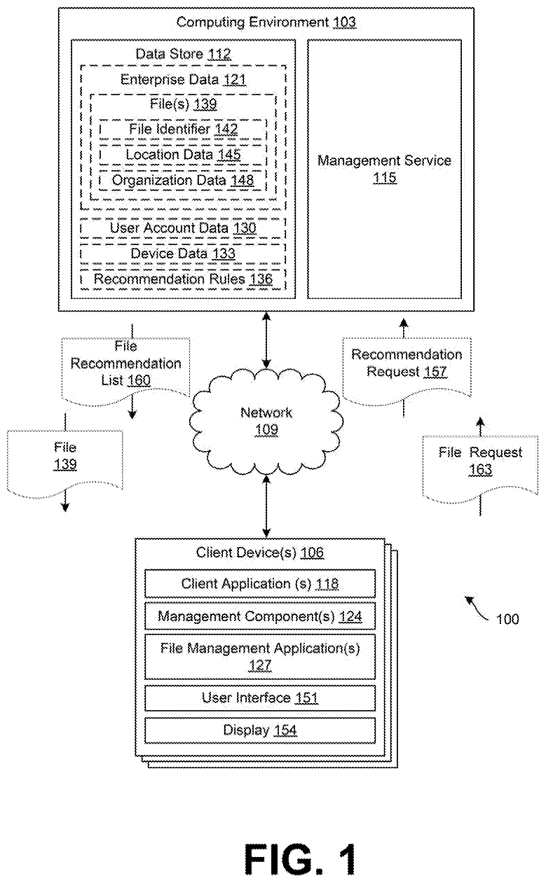

With reference to FIG. 1, shown is an example of a networked environment 100. The networked environment 100 can include a computing environment 103 and client devices 106 in communication with one other over a network 109. The network 109 can include, for example, the Internet, intranets, extranets, wide area networks (WANs), local area networks (LANs), wired networks, wireless networks, other suitable networks, or any combination of two or more such networks. For example, the networks can include satellite networks, cable networks, Ethernet networks, telephony networks, and other types of networks.

The computing environment 103 can include, for example, a server computer or any other system providing computing capability. Alternatively, the computing environment 103 can include a plurality of computing devices that are arranged, for example, in one or more server banks, computer banks, or other arrangements. The computing environment 103 can include a grid computing resource or any other distributed computing arrangement. The computing devices can be located in a single installation or can be distributed among many different geographical locations. The computing environment 103 can also include or be operated as one or more virtualized computer instances. For purposes of convenience, the computing environment 103 is referred to herein in the singular. Even though the computing environment 103 is referred to in the singular, it is understood that a plurality of computing environments 103 can be employed in the various arrangements as described above. As the computing environment 103 communicates with the client devices 106 remotely over the network 109, the computing environment 103 can be described as a “remote” or “cloud” computing environment 103.

The computing environment 103 can include a data store 112. The data store 112 can include memory of the computing environment 103, mass storage resources of the computing environment 103, or any other storage resources on which data can be stored by the computing environment 103. The data stored in the data store 112, for example, can be associated with the operation of the various applications or functional entities described below.

The components executed on the computing environment 103 can include, for example, a management service 115 as well as other applications, services, processes, systems, engines, or functionality not discussed in detail herein. The management service 115 can oversee the operation of multiple client devices 106. In some embodiments, an enterprise, such as one or more companies or other organizations, can operate the management service 115 to oversee or manage the operation of the client devices 106 of its employees, contractors, customers, or other users having user accounts with the enterprise.

The management service 115 can cause various software components to be installed on a client device 106. Such software components can include, for example, client applications 118, resources, libraries, drivers, device configurations and profiles, or other similar components that require installation on the client device 106 as specified by an administrator of the management service 115. The management service 115 can further cause policies to be implemented on a client device 106. Policies can include, for example, restrictions or permissions pertaining to capabilities of a client device 106 such that access to enterprise data 121 is secured on the client device 106.

The management service 115 can interact with one or more client applications 118 executed on the client device 106 to perform management functions. In one example, the management service 115 can interact with a management component 124 on a client device 106 associated with an end user to enroll the client device 106 with the management service 115. The management component 124 can be installed when the client device 106 is enrolled as a managed device with the management service 115. When enrolled, the management component 124 can be registered as a device administrator of the client device 106, which can provide the management component 124 with sufficient privileges to control the operation of the client device 106. In one example, the management component 124 can be registered as the device administrator through the installation of a management profile at the operating system of the client device 106 that causes the operating system to designate the management component 124 as the device administrator.

The management service 115 can direct the management component 124 to perform device management functions on the client device 106. For example, the management service 115 can direct the management component 124 to control access to certain software or hardware functions available on the client device 106. As a result, the management service 115 can verify that the configuration and operation of the client device 106 is in conformance with predefined criteria that ensures that enterprise data 121, or other data, is protected from data loss, unauthorized access, or other harmful events.

The management service 115 can further provision enterprise data 121 to the client device 106 through the management component 124 or file management application 127. In one example, the management service 115 can cause the management component 124 or the file management application 127 to control use of the client device 106 or provision enterprise data 121 to the client device 106 through use of a command queue provided by the management service 115. In some examples, the management service 115 can store commands in a command queue associated with a particular client device 106 and accessible by the particular client device 106. In some examples, the management service 115 can transmit an instruction to an original equipment manufacturer (OEM) messaging service specific to the client devices 106 to cause the OEM specific messaging service to send an instruction to the operating systems of the client device 106, which causes the client device 106 to retrieve commands from the command queues provided by the management service 115. In other examples, the management component 124 is executed by such client device 106 to retrieve the contents of the command queue. In one example, the management component 124 or the file management application 127 can retrieve the contents of the command queue on a configured interval, such as every four hours, or upon detection of a certain event, such as detection of an unauthorized application being executed by the client device 106. The management service 115 can also push commands to the management component 124.

In any case, the management component 124 can receive the contents of the command queue from the management service 115. In one example, the contents of the command queue can include a file recommendation list 160 including one or more files 139 that are determined to be relevant to the user of the requesting device 106 according to organization group and device location. In another example, the contents of the command queue can include a file 139 requested by the file management application 127.

In another application, the command queue can include a command that the management component 124 should cause to be executed on the client device 106. In another example, the contents of the command queue can include a resource or other client application 118 that the management component 124 should cause to be installed on the client device 106, which the client device 106 can access through a specified uniform resource locator (URL).

The data stored in the data store 112 can include, for example, enterprise data 121, user account data 130, device data 133, recommendation rules 136, as well as other data. Enterprise data 121 includes data associated with the enterprise. The enterprise data 121 can include files 139 that can include images, videos, email, corporate documents, social media, messages, enterprise applications, confidential documents, a spreadsheet, a word processing document, or other enterprise content or communications. A file 139 can further include a file identifier 142, location data 145, organization data 148, and other information. The file identifier 142 includes an identifier that is specific to a particular file 139 and can be used to identify the file 139. The file identifier 142 can include a numeric number, a name, or other type of identifier for a file 139.

The location data 145 can include location data identifying geographic locations linked to the particular document. For example, when a user requests access to a particular file 139, the location where the user requests the file 139 can be linked to the file 139 to indicate a relevance between the location and the given file 139. The location data 145 can include global positioning system (GPS) coordinates or any other location identifying data.

The organization data 148 can include organization information identifying organization groups linked to the particular document. For example, when a user of a given organization group requests access to a particular file 139, the organization group associated with the user can be linked to the file 139 to indicate a relevance between the organization group and the given file 139. The organization data can include group identifiers for the organization groups to which the given file 139 is relevant. A group identifier can include a numeric number, a name, or any other type of identifier that can be used to identify the organization group associated with the client device 106 or user account.

An organization group can correspond to an enterprise's internal hierarchy or business structure (e.g., sales, legal, research and development (R&D), R&D for specific product, marketing, accounting, etc.). For example, an enterprise having an engineering team, an accounting team, and a marketing term can have an organization group corresponding to the engineering team, an organization group corresponding to the accounting team, and an organization group corresponding to the marketing team.

In some examples, an administrator can assign an organization group to a client device 106 according to the particular group the employee associated with the client device 106 belongs to within the organization. In other examples, the administrator can assign an organization group to a user account according to the particular group the employee associated with the user account belongs to within the organization. The administrator can assign organization groups as part of enrolling new employees into the management service 115. In some examples, the administrator can update the organization groups as needed. For example, if an employee changes jobs from one group to another group, the administrator can update the assigned organization group to reflect the employee's new group. The administrator can assign the organization groups using a management console that can provide an administrative interface for configuring client devices 106 and user accounts that are administered by the management service 115. The management console can correspond to a web page or web application provided by a web server hosted in the computing environment 103.

The user account data 130 can include information pertaining to end user of the client devices 106 enrolled with the management service 115. For instance, the user account data 130 can include data used to authenticate an end user, such as a user name, password, email address, biometric data, device identifier, registry identifier, or other data. Additionally, the user account data 130 can include other information associated with an end user, such as name, organization unit, or other information.

The device data 133 can include information about the client device 106. The device data 133 can include, for example, information specifying applications that are installed on the client device 106, configurations or settings that are applied to the client device 106, user accounts associated with the device 106, the physical location of the client device 106, the enterprise associated with the client device 106, the network to which the client device 106 is connected, the device group(s) to which the client device 106 belongs, and other information associated with the client device 106.

The recommendation rules 136 include rules, models, or configuration data for the various algorithms or approaches employed by the management service 115. For example, the recommendation rules 136 can include the various algorithms used by the management service 115 to generate the file recommendation list 160 according to a requesting device location and group identifier associated with the requesting device 106. In some implementations, the recommendation rules 136 can include weights to assign to different files 139 to determine relevancy of the file(s) 139 with respect to a user location and group identifier. For example, a sum of the weights can be used to determine which files 139 are recommended and an order in which the recommended files 139 are to be presented to a user on the requesting client device 106.

The client device 106 can be representative of one or more client devices 106. The client device 106 can include a processor-based system, such as a computer system, that can include a desktop computer, a laptop computer, a personal digital assistant, a cellular telephone, a smartphone, a set-top box, a music player, a tablet computer system, a game console, an electronic book reader, or any other device with like capability. The client device 106 can also be equipped with networking capability or networking interfaces, including a localized networking or communication capability, such as a near-field communication (NFC) capability, radio-frequency identification (RFID) read or write capability, or other localized communication capability.

The client device 106 can execute client applications 118, a file management application 127, the management component 124, and other components. Some client applications 118, the file management application 127, and the management component 124 can access network content served up by the computing environment 103 or other servers, thereby rendering a user interface 151 on a display 154, such as a liquid crystal display (LCD), touch-screen display, or other type of display device. To this end, some client applications 118 can include a browser or a dedicated application, and a user interface 151 can include a network page, an application screen, or other interface. Further, other client applications 118 can include device management applications, enterprise applications, social networking applications, word processors, spreadsheet applications, media viewing application, or other applications.

The file management application 127 can include one or more programs that access, manage, edit, or perform other functions with respect to files 139. In some embodiments, the file management application 127 can be regarded as being a “content locker,” because the file management application 127 can cause access to one or more of the files 139 to be restricted. The file management application 127 can generate one or more user interfaces 151 that facilitate a user of the client device 106 being presented with the information that is represented in files to manage, edit, or perform other functions with respect to the presented information. For example, one or more user interfaces 151 of the file management application 127 can facilitate a user editing the content of a file 139, such as a word processing document or spreadsheet. In addition, one or more user interfaces 151 for the file management application 127 can facilitate a user causing a file 139 to be provided to other client devices 106, the management service 115, or other systems. In some examples, the file management application 127 can request a file recommendation list 160 from the management service 115 that includes an identification of files that may be of interest to the user. The recommendation request 157 can include location data 145 and a group identifier of the organization group of the user that can be used by the management service 115 to determine files 139 that may be of interest to the user.

Next, a general description of the operation of the various components of the networked environment 100 is provided. To begin, a user device 106 can be enrolled in the management service 115 that protects enterprise data from theft, loss, and unauthorized access. In some examples, the management component 124 can cause the file management application 127 to be installed on the client device 106 to provide a user access to files 139 associated with the enterprise. When a user accesses the file management application 127, the user will be required to authenticate himself or herself by providing authenticating credentials that can include a user name, user password, group identifier, or other information. The authentication process allows the file management application 127 to identify the particular user as well as identify the organization group to which the particular user belongs.

Upon authentication, the file management application 127 can send a recommendation request 157 to the management service 115 requesting a file recommendation list 160 for the given user. The recommendation request 157 can include a user identification (ID), a device location (e.g., global positioning system (GPS) location), an organization group identifier, and other information. The management service 115 can receive the request 157 and determine if there are any files 139 to recommend to the user according to the current device location and the group identifier. For example, as employees access and modify files 139 according to task, the management service 115 can use machine learning to determine which files are typically accessed by end users based on the organization group of the user and the device location. The management service 115 can then associate specific enterprise files 139 to the device location and the group identifier. If there are no files 139 to recommend to the user, the management service 115 can notify the file management application 127 that there are no recommended files 139, and the user can proceed with navigating the accessible files 139 through a file directory and selecting the desired file 139. In this situation, the management service 115 can identify the files 139 that the particular user requests, and recommend these files 139 to subsequent requesting devices 106 of users in the same organization group and at the same geographic location.

However, if there are files 139 to recommend to the user based on the client location and the group identifier, the management service 115 can generate a recommended files list 160 to present to the user. The file recommendation list 160 can be generated based on the geographic device location and group identifier associated with the client device 106 and user requesting access to enterprise files. Other factors for identifying and generating the file recommendation list 160 can include user account data 130, user permissions, device data 133, and other information. In some implementations, the order of files in the file recommendation list 160 can vary according to the requesting user. For example, assume File 1 and File 2 are identified as commonly accessed files 139 for users in Organization Group 1 at geographic location X. If User A in Organization Group 1 has previously accessed File 2 and User B in Organization Group 1 has previously accessed File 1, the order of presented files for User A can be File 2, File 1, while the order of presented files for User B can be File 1, File 2.

The file management application 127 can access the file recommendation list 160 through the management service 115 and render a user interface 151 including the file recommendation list 160 to present to the user. If a desired file 139 of the user is included in the file recommendation list 160, the user can select the desired file 139 instead of having to navigate through a file directory to access the desired file 139. According to various implementations, if the desired file 139 is not included in the file recommendation list 160, the user can reject the recommended files 139 and proceed with navigating through the directory of accessible files 139 to locate the desired file 139. In this situation, the file management application 127 can request feedback from the user to determine why the recommended files 139 were rejected. The file management application 127 can transmit the feedback data to the management service 115, which can dynamically update the criteria and recommendation rules 136 for recommending files 139 according to the user feedback.

When a user selects a file 139 to access, the file management application 127 can send a file request 163 to the management service 115 which in turn causes the file 139 to be distributed to the client device 106. In one example, the management service 115 can push the file 139 to the client device 106. In another example, the file management application 127 or management component 124 can access the file 139 through the command queue associated with the management service 115.

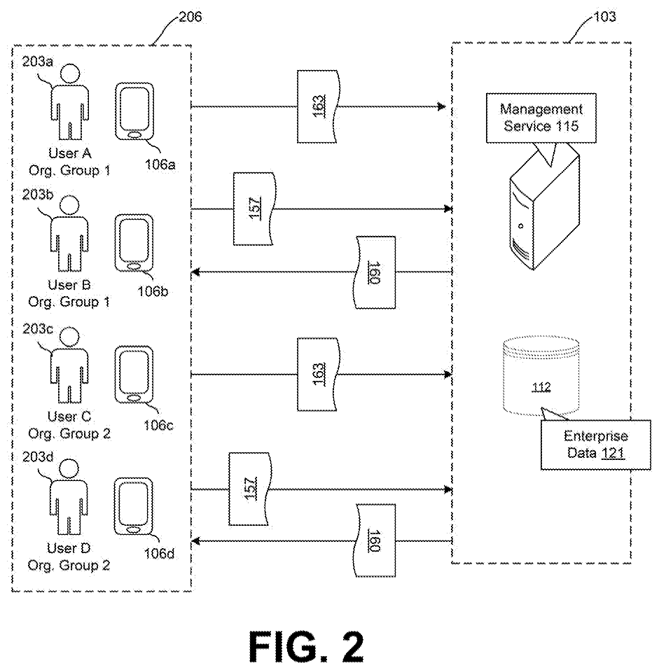

Turning now to FIG. 2, shown is a diagram that provides one example of the functionality implemented by the networked environment 100. To begin, shown are users 203a, 203b, 203c, and 203d (hereinafter “users 203”) with corresponding client devices 106a, 106b, 106c, and 106d located in geographic location 206. For the purposes of the example, the users 203 are not located at the geographic location 206 at the same time.

In this example, User A of Organization Group 1 reaches location 206 and opens the file management application 127 on his or her client device 106a to view a list of available contents. In some examples, the user 203a can be required to authenticate himself or herself by entering security credentials using one or more user interfaces 151 of the file management application 127. Assume that there are no recommended files 139 for the user 203a to view and that the user 203a navigates through a file directory and selects a file 139. The file management application 127 can transmit a file request 163 to the management service 115 in the computing environment 103. The file request 163 includes the file identifier 142, location data 145, user identifier, and group identifier of the organization group of the user 203a. The management service 115 can access the file 139 from the enterprise data 121 in the data store 112 and cause the file 139 to be distributed to the client device 106a. In addition, the management service 115 can link the requested file 139 with the location data 145 and the group identifier associated with the requesting device 106 or user 203a. This data can be used to generate a file recommendation list 160 for subsequent users in the same location 206 that are part of the same organization group.

When User B of Organization Group 1 reaches location 206 following User A, User B can open the file management application 127 on the client device 106 to get a list of available contents. When User B is authenticated, the file management application 127 can transmit a recommendation request 157 to the management service 115 requesting a list of recommended files 139. Upon receipt of the recommendation request 157, the management service 115 can generate a file recommendation list 160 according to the recommendation rules 136, the location data 145 and the organization group identifier. Since User B is in the same location 206 and in the same organization group as User A, the management service 115 the file recommendation list 160 can include the file 139 requested by User A. The management service 115 can cause the file recommendation list 160 to be distributed to the client device 106b associated with User B. When the file management application 127 accesses the file recommendation list 160, the file management application 127 can render a user interface 151 including the recommended files 139. At this time, User B can select a recommended file 139 or reject the recommended files. If User B selects a recommended file 139, the file management application can transmit a file request 163 to the management service 115 which in turn updates the file data, including the file identifier 142, location data 145, and organization data 148.

If User B rejects the recommended files, the file management application 127 can request feedback from the user to determine why the user 203b rejected the recommended files. The file management application 127 can transmit the feedback back to the management service 115, and the management service 115 can update the recommendation rules 136 and file data to reflect the feedback of the user.

When User C of Organization Group 2 reaches location 206 following User A and User B, User C can open the file management application 127 on the client device 106c to get a list of available contents. When User C is authenticated, the file management application 127 can transmit a recommendation request 157 to the management service 115 requesting a list of recommended files 139. Since the management service 115 does not have any information associated with the group identifier for Organization Group 2, the management service 115 does not provide client device 106c with a file recommendation list 160, and User C can proceed with navigating through the file directory to locate the desired file 139. Upon receiving a selection of a particular file 139, the file management application 127 can transmit a file request 163 to the management service 115 which in turn provides the requested file 139 to the requesting device 106c.

Finally, when User D of Organization Group 2 reaches location 206 following User C, User D opens the file management application 127 on the client device 106c to get a list of available contents. When User D is authenticated, the file management application 127 transmits a recommendation request 157 to the management service 115. Since User D is in the same organization group as User C, the management service 115 has information associated with relevant files for Organization 2 linked to the location 206 and can provide a recommendation file list 160 to User D.

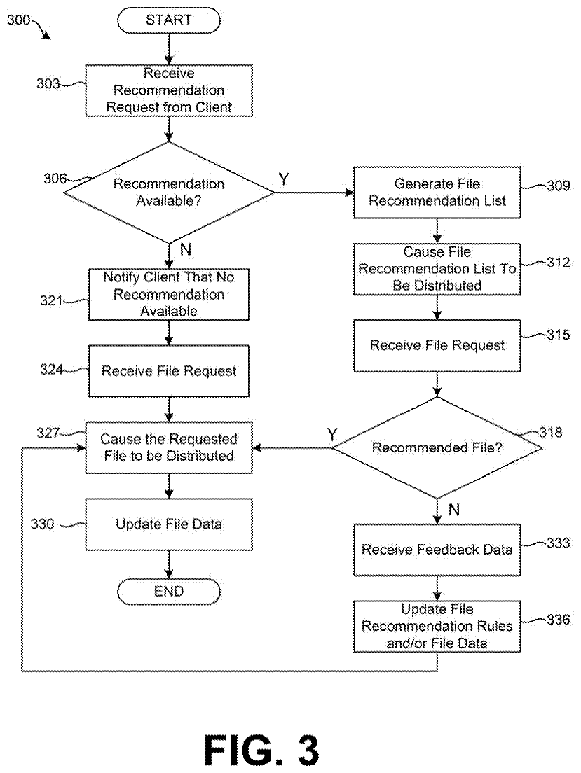

Turning now to FIG. 3, shown is a flowchart 300 that provides one example of the operation of a portion of the computing environment 103. The flowchart of FIG. 3 can be viewed as depicting an example of elements of a method implemented by the management service 115 or other suitable software component according to one or more examples. The separation or segmentation of functionality as discussed herein is presented for illustrative purposes only.

In step 303, the management service 115 receives a recommendation request 157 from a client device 106. The recommendation request 157 can include a user identifier, location data 145, an organization group identifier associated with the requesting device 106, and other information.

In step 306, the management service 115 determines if there are any files 139 to recommend to the requesting device 106 according to the location data 145 and the group identifier. For example, the management service 115 can determine if any files 139 have previously been requested by users at the same location 206 that are within the same organization group. The management service 115 can further identify files 139 according to permissions or restrictions associated with the user account of the requesting device 106.

If the management service 115 fails to identify files 139 that can be recommended to the requesting device 106, the management service proceeds to step 321 and notifies the file management application 127 of the client device 106 that there are not files to recommend.

In step 324, the management service 115 can receive a file request 163 from the file management application 127. For example, although there were no files 139 to recommend, the user can navigate through a file directory using the file management application 127 and select a desired file. The selection of the desired file 139 generates the file request 163 received by the management service 115.

In step 327, the management service 115 causes the requested file 139 to be distributed to the client device 106. For example, the management service 115 can push the file 139 to the client device 106. In another example, the management service 115 can place the file 139 in a command queue corresponding to the client device 106 and the file management application 127 or management component 124 can obtain the file 139 from the command queue.

In step 330, the management service 115 can update the file data to associate or otherwise link the requested file 139 with the location data 145 and group identifier. Thereafter, this process proceeds to completion.

Referring back to step 306, if there are files 139 to recommend, the management service 115 proceeds to step 309 and generates a file recommendation list 160. For example, the management service 115 can use the recommendation rules 136 to select which files to recommend to the requesting device 106. The recommended files 139 include files that have been previously linked to the location 206 and organization group. In some implementations, the management service 115 select a subset of the recommended files 139 that are linked to the same location and organization group according to one or more factors. The factors can include user account data 130, device data 133, user identifier, or other information. In some implementations, the management service 115 can determine an order to present the files 139 that is specific to a particular user.

In step 312, the management service 115 can cause the file recommendation list 160 to be distributed to the client device 106. For example, the management service 115 can push the file recommendation list 160 to the client device 106. In another example, the management service 115 can place the file recommendation list 160 in a command queue corresponding to the client device 106 and the file management application 127 or the management component 124 can obtain the file recommendation list 160 from the command queue.

In step 315, the management service 115 can receive a file request 163 from the file management application 127 or management component 124. The file request 163 includes a file identifier 142, user identifier, location data 145, group identifier, and other information.

In step 318, the management service 115 determines whether the requested file 163 was included in the file recommendation list 160. For example, the management service 115 can compare the file identifier 142 in the file request 163 with a file identifier 142 included in the file recommendation list 160 to determine if there is a match. If the requested file 163 is selected, the management service 115 proceeds to step 327 where the management service 115 causes the requested file 139 to be distributed to the client device 106.

If the requested file 139 is not a recommended file 139, the management service 115 proceeds to step 333, where the management service 115 receives feedback data from the client device 106. In particular, the feedback data includes information related to why the user did not select a recommended file 139. For example, the feedback data can indicate that the recommended file 139 is not relevant to the task that the user is currently performing or that the recommended file 139 is not relevant to the user.

In step 336, the management service 115 updates the recommendation rules 136 and or file data to reflect the feedback of the user. For example, the recommendation rules 136 can be updated such that a weight applied to the one or more of the factors associated with the particular file are reduced according to the feedback data. In another example, the file data can be updated to unlink the location and group identifier with the particular file 139. Upon updating the recommendation rules 136 and the file data, the management service 115 proceeds to step 327 where the requested file 139 is distributed to the client device 106.

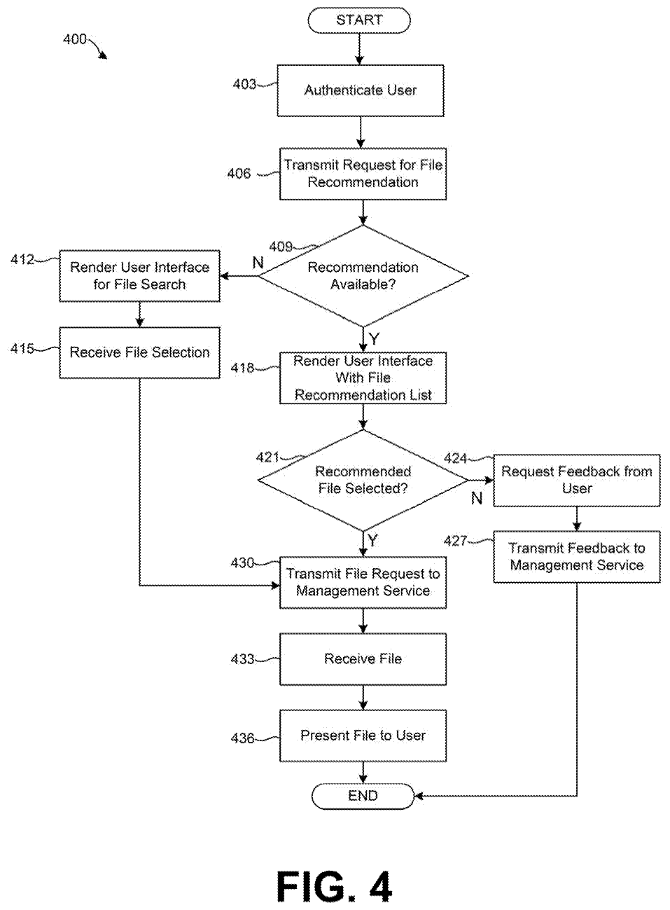

Moving on to FIG. 4, shown is a flowchart 400 that provides one example of the operation of a portion of the client device 106. The flowchart of FIG. 4 can be viewed as depicting an example of elements of a method implemented by the management component 124, file management application 127, or other suitable software component according to one or more examples. The separation or segmentation of functionality as discussed herein is presented for illustrative purposes only.

In step 403, the file management application 127 or management component 124 authenticates the user interacting with the client device 106. For example, when a user opens the file management application 127, the user can be prompted to provide security credentials that can be used to identify and authenticate the user interacting with the device 106. In some implementations, the file management application 127 or management component 124 can provide the received security credentials to the management service 115 to verify the user and complete the authentication of the user. By authenticating the user, the file management application 127 is able to identify the user and group identifier associated with the user.

In step 406, the file management application 127 transmits a recommendation request 157 to the management service 115. The recommendation request 157 includes location data 145 associated with the client device 106, the group identifier, a user identifier, device data 133, and other information. For example, the file management application 127 or the management component 124 can obtain location data 145 by interacting with a GPS peripheral device of the client device 106.

In step 409, the file management application 127 determines if there are any recommendations available for the particular device 106. For example, if the management service 115 identities accessible files 139 to include in a file recommendation list 160 according to device location 206 and group identifier, the file management application 127 can receive the file recommendation list 160 from the management service 115 and proceed to step 418. Otherwise, the management service 115 can transmit a notification to the file management application 127 notifying the file management application 127 that a file recommendation list 160 is not available. In this instance, the file management application 127 proceeds to step 412.

In step 412, the file management application 127 can render a user interface 151 that facilitates a user to navigate through the file directory to find a desired file 139, and when there is not a file recommendation list 160 to present to the user and in step 415, the file management application 127 receives a file selection of a file accessible to the user.

In step 418, the file management application 127 can render a user interface 151 that includes a file recommendation list 160 received from the management service 115 when there is a recommendation available. The file recommendation list 160 can include an identification of one or more files 139 that the management service 115 has determined to be relevant to the user according to device location 206 and the group identifier associated with the user or requesting device 106.

In step 421, the file management application 127 determines if a recommended file 139 has been selected. The user interface 151 can include selectable components for selecting the recommended files 139. The user interface 151 can also include selectable components for rejecting the recommended files or selecting files 139 other than those recommended. If a selectable component for rejecting the recommended files or a file 139 other than those recommended is selected, the file management application 127 proceed to step 424. Otherwise, if a selectable component for a recommended file 139 is selected, the file management application 127 proceeds to step 430.

In step 424, the file management application 127 can request feedback from the user when the user has rejected the recommended files 139. For example, the file management application 127 can render a user interface 151 that allows a user to provide feedback related to the relevancy of the recommended documents.

In step 427, the file management application 127 transmits the received feedback to the management service 115 which can update the recommendation rules 136 and file data to reflect the feedback of the user. Thereafter, the process can proceed to completion.

In step 430, the file management application 127 transmits a file request 163 to the management service 115 following receiving a file selection in step 415 or receiving a recommended file selection in step 421.

In step 433, the file management application 127 receives the file 139 from the management service 115. In some examples, the management service 115 pushes the file 139 to the client device 106. In other examples, the file management application 127 or management component 124 obtains the file 139 from the command queue associated with the management service 115.

In step 436, the file management application 127 can present the file 139 to the user where the user can modify, review, update, or otherwise interact with the file to complete a given task. Thereafter, the process can proceed to completion.

A number of software components are stored in the memory and executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory can include both volatile and nonvolatile memory and data storage components. Also, a processor can represent multiple processors or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

Although the management service 115, client applications 118, management components 124, file management application 127, and other various services and functions described can be embodied in software or code executed by general purpose hardware as discussed above, as an alternative, the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include discrete logic circuits having logic gates for implementing various logic functions upon an application of one or more data signals, application specific integrated circuits (ASICs) having appropriate logic gates, field-programmable gate arrays (FPGAs), or other components.

The flowcharts show an example of the functionality and operation of an implementation of portions of components described. If embodied in software, each block can represent a module, segment, or portion of code that can include program instructions to implement the specified logical function(s). The program instructions can be embodied in the form of source code that can include human-readable statements written in a programming language or machine code that can include numerical instructions recognizable by a suitable execution system such as a processor in a computer system or other system. The machine code can be converted from the source code. If embodied in hardware, each block can represent a circuit or a number of interconnected circuits to implement the specified logical function(s).

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, one or more of the blocks shown in the drawings can be skipped or omitted.

Also, any logic or application described that includes software or code can be embodied in any non-transitory computer-readable medium for use by or in connection with an instruction execution system such as a processor in a computer system or other system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described can be implemented and structured in a variety of ways. For example, one or more applications can be implemented as modules or components of a single application. Further, one or more applications described can be executed in shared or separate computing devices or a combination thereof. For example, a plurality of the applications described can execute in the same computing device, or in multiple computing devices.

It is emphasized that the above-described embodiments of the present disclosure are merely possible examples of implementations described for a clear understanding of the principles of the disclosure. Many variations and modifications can be made to the above-described embodiments without departing substantially from the spirit and principles of the disclosure. All such modifications and variations are intended to be included within the scope of this disclosure.

What is claimed is:

1. A system for recommending files, the system comprising:
at least one computing device; and
at least one application executable in the at least one computing device, wherein the at least one application, when executed, causes the at least one computing device to:
receive a recommendation request from a client device enrolled in a management service, the recommendation request comprising a device location and a group identifier for an organization group within an enterprise that is associated with at least one of the client device or a user of the client device;
identify a file stored in a database based on the device location and the group identifier;
generate a file recommendation list comprising the file; and
distribute the file recommendation list to the client device.

2. The system of claim 1, wherein, when executed, the at least one application further causes the at least one computing device to at least:
receive a file request from the client device, the file request comprising a file identifier; and
distribute the file to the client device.

3. The system of claim 2, wherein the file comprises a first file, and when executed, the at least one application further causes the at least one computing device to at least:
determine that the file identifier included in the file request differs from a file identifier of the file included in the file recommendation list, the file comprising a first file;
identify a second file associated with the file identifier of the file request; and
wherein the file distributed to the client device comprises the second file.

4. The system of claim 3, wherein, when executed, the at least one application further causes the at least one computing device to at least:
receive feedback data from the client device in an instance in which the file identifier included in the file request differs from the file identifier of the first file; and
update file data associated with at least one of the first file or the second file based at least in part on the feedback data, the device location, and the group identifier.

5. The system of claim 1, wherein, when executed, the at least one application further causes the at least one computing device to at least push the file recommendation list to the client device.

6. The system of claim 1, wherein the client device comprises a first client device, and, when executed, the at least one application further causes the at least one computing device to at least:
receive a file request from a second client device enrolled in the management service, the file request comprising a file identifier, the device location, and the group identifier; and
associate the file with the device location and the group identifier.

7. The system of claim 1, wherein the file is one of a plurality of files included in the recommendation file list, each file being associated with the device location and the group identifier according to at least one prior file request including the device location and the group identifier.

8. A computer-implemented method for recommending files, comprising:
receiving, by at least one computing device, a recommendation request from a client device enrolled in a management service, the recommendation request comprising a device location and a group identifier for an organization group within an enterprise that is associated with at least one of the client device or a user of the client device;
identifying, by the at least one computing device, a file stored in a database based at least in part on the device location and the group identifier;
generating, by the at least one computing device, a file recommendation list comprising the file; and
distributing, by the at least one computing device, the file recommendation list to the client device.

9. The computer-implemented method of claim 8, further comprising:
receiving, by the at least one computing device, a file request from the client device, the file request comprising a file identifier; and
distributing, by the at least one computing device, the file to the client device.

10. The computer-implemented method of claim 9, wherein the file comprises a first file, and further comprising:
determining, by the at least one computing device, that the file identifier included in the file request differs from a file identifier of the file included in the file recommendation list, the file comprising a first file;
identifying, by the at least one computing device, a second file associated with the file identifier of the file request; and
wherein the file distributed to the client device comprises the second file.

11. The computer-implemented method of claim 10, further comprising:
receiving, by the at least one computing device, feedback data from the client device in an instance in which the file identifier included in the file request differs from the file identifier of the first file; and
updating, by the at least one computing device, file data associated with at least one of the first file or the second file based at least in part on the feedback data, the device location, and the group identifier.

12. The computer-implemented method of claim 8, further comprising pushing the file recommendation list to the client device.

13. The computer-implemented method of claim 8, wherein the client device comprises a first client device, and further comprising:
receiving, by the at least one computing device, a file request from a second client device enrolled in the management service, the file request comprising a file identifier, the device location, and the group identifier; and
associating, by the at least one computing device, the file with the device location and the group identifier.

14. The computer-implemented method of claim 8, wherein the file is one of a plurality of files included in the recommendation file list, each file being associated with the device location and the group identifier according to at least one prior file request including the device location and the group identifier.

15. A non-transitory computer-readable medium embodying a program executable in a computing device, wherein when executed, the program causes the computing device to at least:
receive a recommendation request from a client device enrolled in a management service, the recommendation request comprising a device location and a group identifier for an organization group within an enterprise that is associated with at least one of the client device or a user of the client device;
identify a file stored in a database based at least in part on the device location and the group identifier;
generate a file recommendation list comprising the file; and
distribute the file recommendation list to the client device.

16. The non-transitory computer-readable medium of claim 15, wherein, when executed, the program further causes the computing device to at least:
receive a file request from the client device, the file request comprising a file identifier; and
distribute the file to the client device.

17. The non-transitory computer-readable medium of claim 16, wherein the file comprises a first file, and when executed, the program further causes the computing device to at least:
determine that the file identifier included in the file request differs from a file identifier of the file included in the file recommendation list, the file comprising a first file;
identify a second file associated with the file identifier of the file request; and
wherein the file distributed to the client device comprises the second file.

18. The non-transitory computer-readable medium of claim 17, wherein, when executed, the program further causes the computing device to at least:
receive feedback data from the client device in an instance in which the file identifier included in the file request differs from the file identifier of the first file; and
update file data associated with at least one of the first file or the second file based at least in part on the feedback data, the device location, and the group identifier.

19. The non-transitory computer-readable medium of claim 15, wherein, when executed, the program further causes the computing device to at least push the file recommendation list to the client device.

20. The non-transitory computer-readable medium of claim 15, wherein, when executed, the program further causes the computing device to at least:
receive a file request from a second client device enrolled in the management service, the file request comprising a file identifier, the device location, and the group identifier; and
associate the file with the device location and the group identifier.
